(19) United States
(12) Patent Application Publication
(10) Pub. No.: US 2020/0026638 A1
(43) Pub. Date: Jan. 23, 2020

(54) Method and System for Implementing Data Flow or Code Analysis Using Code Division

(71) Applicant: CenturyLink Intellectual Property LLC, Broomfield, CO (US)

(72) Inventor: Ronald A. Lewis, Bastrop, LA (US)

(21) Appl. No.: 16/119,296

(22) Filed: Aug. 31, 2018

Related U.S. Application Data
(60) Provisional application No. 62/700,122, filed on Jul. 18, 2018.

(51) Int. Cl. G06F 11/36

(52) U.S. Cl. CPC G06F 11/3612; G06F 11/3672

(57) ABSTRACT

Novel tools and techniques are provided for implementing data flow or code analysis, and, more particularly, to methods, systems, and apparatuses for implementing analysis of data flow or code using code division. In various embodiments, a computing system might receive a software code for testing, might identify at least one divisible point for each of one or more portions of the received software code, and might divide the software code into the one or more portions based on the identified divisible points. Each of the one or more portions, after being divided, is an atomic element of the software code that is capable of execution independent of other portions of the software code. The computing system might analyze at least one portion of the one or more portions of the received software code, each portion being analyzed separately from analysis of other portions of the received software code.

### CROSS-REFERENCES TO RELATED APPLICATIONS

This application claims priority to U.S. Patent Application Ser. No. 62/700,122 (the “'122 Application”), filed on Jul. 18, 2018 by Ronald A. Lewis (attorney docket no. 1504-US-P1), entitled, “Method and System for Implementing Data Flow or Code Analysis Using Code Division,” the disclosure of which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing data flow or code analysis, and, more particularly, to methods, systems, and apparatuses for implementing analysis of data flow or code using code division.

### BACKGROUND

In conventional data flow or code analysis, analysis is performed on the entire software code (i.e., source code or the like) one line after another from first line to last line. Each time a segment of the software code is changed to address a coding issue, a software “bug,” vulnerabilities, a coding error(s), or other errors, or the like, the entire software code must once again be analyzed. As software code becomes more and more complex, and can contain millions upon millions of lines of code, such conventional data flow or code analysis becomes extremely time-consuming, requiring hours upon hours of testing, compiling, and/or executing time.

Hence, there is a need for more robust and scalable solutions for implementing data flow or code analysis, and, more particularly, to methods, systems, and apparatuses for implementing analysis of data flow or code using code division.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram illustrating a system for implementing analysis of data flow or code using code division, in accordance with various embodiments.

FIG. 2 is a schematic diagram illustrating an example of the structure of a conventional software code.

FIGS. 3A and 3B are schematic diagrams illustrating an example of the structure of software code that may be code divided during implementation of analysis of data flow or code, in accordance with various embodiments.

FIGS. 4A-4D are flow diagrams illustrating a method for implementing analysis of data flow or code using code division, in accordance with various embodiments.

FIG. 5 is a block diagram illustrating an exemplary computer or system hardware architecture, in accordance with various embodiments.

FIG. 6 is a block diagram illustrating a networked system of computers, computing systems, or system hardware architecture, which can be used in accordance with various embodiments.

### DETAILED DESCRIPTION OF CERTAIN EMBODIMENTS

### Overview

Various embodiments provide tools and techniques for implementing data flow or code analysis, and, more particularly, to methods, systems, and apparatuses for implementing analysis of data flow or code using code division.

In various embodiments, a computing system might receive a software code for testing. At least one divisible point for each of one or more portions of the received software code might be identified (either manually or using the computing system). In some embodiments, the computing system might divide the software code into the one or more portions based at least in part on the identified at least one divisible point for each of the one or more portions of the received software code. According to some embodiments, the computing system might analyze at least one portion of the one or more portions of the received software code—to check for or identify software “bugs,” errors, vulnerabilities, coding inefficiencies, or other coding defects, and/or the like—, where each of the at least one portion might be analyzed separately from analysis of other ones of the at least one portion of the received software code.

The various embodiments provide advantages over conventional data flow or code analysis in that by using code division in accordance with the various embodiments, software code may be divided into multiple code portions along logical breaking points such that each of the multiple code portions may be executed properly or as intended, while being executed independently of other code portions. The advantages of such code division include that when the code is being tested prior to launch of the software code as a product or service, such divided portions may be tested without the need to test other portions. Thus, any changes to particular portions of the code need only necessitate testing, software compilation, and/or execution of those particular portions without having to test, compile, or execute unchanged portions of the code. This results in vastly more efficient testing of the code (and in a less time-consuming manner), as the whole software code need not be tested, compiled, or executed in view of the change to just a portion(s) of the software code (as would be required by conventional data flow or code analysis). Not only is such testing of the software code made more efficient during pre-launch testing that seek to identify software “bugs,” errors, vulnerabilities, coding inefficiencies, or other coding defects, but such methodologies may be implemented after launch should software “bugs,” errors, vulnerabilities, coding inefficiencies, or other coding defects be found in at least some portions of the software code. In those situations, only the affected portions need be changed and tested, after code division (in accordance with the various embodiments). In this manner, data flow analysis or code analysis may be performed in a significantly shorter time compared with conventional data flow analysis or code analysis techniques—from hours to minutes.

Further, by using the code division (as described in accordance with the various embodiments), regular software compilation (or alternatively, regular execution) of the software code may be made more efficient and less time-consuming, as the divided code portions may be compiled (or executed) concurrently or in parallel with each other, thereby significantly reducing the time by which the software code is compiled (or executed), from hours to minutes.

These and other features and advantages of the various embodiments are described in detail below with respect to the figures. Most modern development leverages atomic functionality based on object-oriented design, rather than top-down structured methodologies. Developmental methodologies have evolved, but methods and processes for evaluating source code have not—still centering around top-down evaluation, following each individual logic branch using a cyclic complexity-based method. The various embodiments of the code division methodologies described herein are tailored toward and leverage the atomic functionality based on object-oriented design, in line with modern development, while disproving conventional top-down techniques that assume code cannot be divided without losing visibility to data flows through the various program paths.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments described herein, while embodying (in some cases) software products, computer-performed methods, and/or computer systems, represent tangible, concrete improvements to existing technological areas, including, without limitation, data flow analysis technology, code analysis technology, software debugging technology, software optimization technology, and/or the like. In other aspects, certain embodiments can improve the functioning of user equipment or systems themselves (e.g., data flow analyzers, code analyzers, software debugging systems, software optimization systems, etc.), for example, by identifying at least one divisible point for each of one or more portions of software code; dividing, with a computing system, the software code into the one or more portions based at least in part on the identified at least one divisible point for each of the one or more portions of the received software code; and analyzing, with the computing system, at least one portion of the one or more portions of the received software code—to check for or identify software “bugs,” errors, vulnerabilities, coding inefficiencies, or other coding defects, and/or the like—, wherein each of the at least one portion is analyzed separately from analysis of other ones of the at least one portion of the received software code; and/or the like. In particular, to the extent any abstract concepts are present in the various embodiments, those concepts can be implemented as described herein by devices, software, systems, and methods that involve specific novel functionality (e.g., steps or operations), such as, dividing the software code into multiple code portions along logical breaking points such that each of the multiple code portions may be executed properly or as intended, while being executed independently of other code portions, and/or the like, to name a few examples, that extend beyond mere conventional computer processing operations. These functionalities can produce tangible results outside of the implementing computer system, including, merely by way of example, optimized and efficient analysis of data flow or code regardless of length of code (i.e., regardless of whether the code is millions of lines of code or more), and/or the like, at least some of which may be observed or measured by programmers, data flow analysts, code analysts, and/or service providers, or the like.

In an aspect, a method might comprise receiving, with a computing system, a software code for testing; identifying at least one divisible point for each of one or more portions of the received software code; and dividing, with the computing system, the software code into the one or more portions based at least in part on the identified at least one divisible point for each of the one or more portions of the received software code, wherein each of the one or more portions, after being divided, is an atomic element of the software code that is capable of execution independent of other portions of the software code. The method might further comprise analyzing, with the computing system, at least one portion of the one or more portions of the received software code (to check for or identify software “bugs,” errors, vulnerabilities, coding inefficiencies, or other coding defects, and/or the like), wherein each of the at least one portion is analyzed separately from analysis of other ones of the at least one portion of the received software code.

In some embodiments, the computing system might comprise one of a data flow analyzer, a code analyzer, a software debugging system, a processor of a user device running an app, a server computer over a network, a cloud-based computing system over a network, or a distributed computing system, and/or the like. In some cases, the software code for testing might comprise at least one of source code, code for a software application, code for a computer game, code for a web application, code for a computer program, code for an operating system, or code for transferring data, and/or the like. In some instances, the at least one divisible point might be a logical breaking point between two portions of the one or more portions of the received software code.

According to some embodiments, identifying the at least one divisible point for each of the one or more portions of the received software code might comprise identifying at least one divisible point for each of one or more portions of the received software code based at least in part on critical dependencies of the software code. Alternatively, and/or additionally, identifying the at least one divisible point for each of the one or more portions of the received software code might comprise identifying, with the computing system, at least one divisible point for each of one or more portions of the received software code based at least in part on contents of at least one of a build file, a manifest file, a class file, or a Java archive (“JAR”) file, and/or the like, that is associated with the software code. In some instances, identifying the at least one divisible point for each of the one or more portions of the received software code based at least in part on contents of the at least one of the build file, the manifest file, the class file, or the JAR file might comprise analyzing, with the computing system, the contents of the at least one of the build file, the manifest file, the class file, or the JAR file associated with the software code to identify one or more critical dependencies of the software code; and identifying, with the computing system, at least one divisible point for each of one or more portions of the received software code based at least in part on the one or more identified critical dependencies of the software code.

In some cases, dividing the software code into the one or more portions based at least in part on the identified at least one divisible point for each of the one or more portions of the received software code might comprise dividing the software code into the one or more portions without preventing execution of each of the one or more portions of the received software code.

In some instances, analyzing the at least one portion of the one or more portions of the received software code might comprise: comparing, with the computing system, each of the one or more portions of the received software code with a previous version of the corresponding one or more portions of the received software code to identify which portions of the received software code has changed; and analyzing, with the computing system, each of the identified changed portions of the received software code.

In another aspect, an apparatus might comprise at least one processor and a non-transitory computer readable medium communicatively coupled to the at least one processor. The non-transitory computer readable medium might have stored thereon computer software comprising a set of instructions that, when executed by the at least one processor, causes the apparatus to: receive a software code for testing; identify at least one divisible point for each of one or more portions of the received software code; divide the software code into the one or more portions based at least in part on the identified at least one divisible point for each of the one or more portions of the received software code, wherein each of the one or more portions, after being divided, is an atomic element of the software code that is capable of execution independent of other portions of the software code; and analyze at least one portion of the one or more portions of the received software code, wherein each of the at least one portion is analyzed separately from analysis of other ones of the at least one portion of the received software code.

In some embodiments, the apparatus might comprise one of a data flow analyzer, a code analyzer, a software debugging system, a processor of a user device running an app, a server computer over a network, a cloud-based computing system over a network, or a distributed computing system, and/or the like. In some cases, the software code for testing might comprise at least one of source code, code for a software application, code for a computer game, code for a web application, code for a computer program, code for an operating system, or code for transferring data, and/or the like. In some instances, the at least one divisible point might be a logical breaking point between two portions of the one or more portions of the received software code.

According to some embodiments, identifying the at least one divisible point for each of the one or more portions of the received software code might comprise identifying at least one divisible point for each of one or more portions of the received software code based at least in part on critical dependencies of the software code. Alternatively, and/or additionally, identifying the at least one divisible point for each of the one or more portions of the received software code might comprise identifying at least one divisible point for each of one or more portions of the received software code based at least in part on contents of at least one of a build file, a manifest file, a class file, or a Java archive (“JAR”) file, and/or the like, that is associated with the software code. In some instances, identifying the at least one divisible point for each of the one or more portions of the received software code based at least in part on contents of the at least one of the build file, the manifest file, the class file, or the JAR file might comprise analyzing the contents of the at least one of the build file, the manifest file, the class file, or the JAR file associated with the software code to identify one or more critical dependencies of the software code; and identifying at least one divisible point for each of one or more portions of the received software code based at least in part on the one or more identified critical dependencies of the software code.

In some cases, dividing the software code into the one or more portions based at least in part on the identified at least one divisible point for each of the one or more portions of the received software code might comprise dividing the software code into the one or more portions without preventing execution of each of the one or more portions of the received software code.

In some instances, analyzing the at least one portion of the one or more portions of the received software code might comprise: comparing each of the one or more portions of the received software code with a previous version of the corresponding one or more portions of the received software code to identify which portions of the received software code has changed; and analyzing each of the identified changed portions of the received software code.

In yet another aspect, a system might comprise a computing system. The computing system might comprise at least one processor and a non-transitory computer readable medium communicatively coupled to the at least one processor. The non-transitory computer readable medium might have stored thereon computer software comprising a set of instructions that, when executed by the at least one processor, causes the computing system to: receive a software code for testing; identify at least one divisible point for each of one or more portions of the received software code; divide the software code into the one or more portions based at least in part on the identified at least one divisible point for each of the one or more portions of the received software code, wherein each of the one or more portions, after being divided, is an atomic element of the software code that is capable of execution independent of other portions of the software code; and analyze at least one portion of the one or more portions of the received software code, wherein each of the at least one portion is analyzed separately from analysis of other ones of the at least one portion of the received software code.

In some embodiments, the computing system might comprise one of a data flow analyzer, a code analyzer, a software debugging system, a processor of a user device running an app, a server computer over a network, a cloud-based computing system over a network, or a distributed computing system, and/or the like.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### Specific Exemplary Embodiments

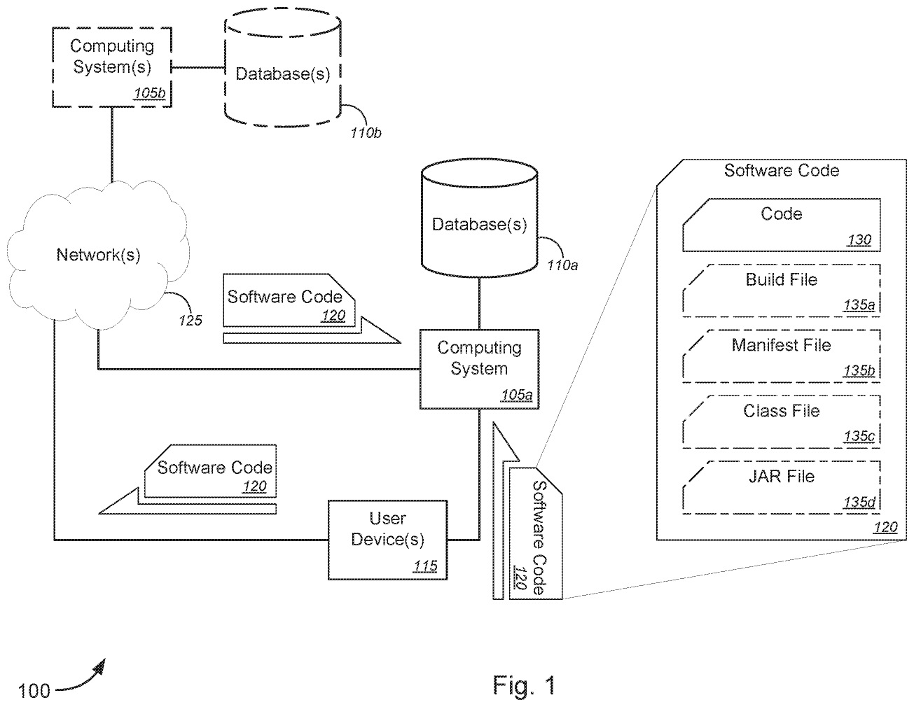

We now turn to the embodiments as illustrated by the drawings. FIGS. 1-6 illustrate some of the features of the method, system, and apparatus for implementing data flow or code analysis, and, more particularly, to methods, systems, and apparatuses for implementing analysis of data flow or code using code division, as referred to above. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

With reference to the figures, FIG. 1 is a schematic diagram illustrating a system 100 for implementing analysis of data flow or code using code division, in accordance with various embodiments.

In the non-limiting embodiment of FIG. 1, system 100 might comprise a computing system 105a and corresponding database(s) 110a. System 100 might further comprise one or more user devices 115. In some cases, the one or more user devices 115 might be local to the computing system 105a and corresponding database(s) 110a. According to some embodiments, software code 120 might be received by computing system 105a either from the one or more user devices 115 or from a source (not shown) via network(s) 125. Alternatively, software code 120 might be received by a remote computing system 105b (and corresponding database(s) 110b) from the one or more user devices 115 via network(s) 125.

In some embodiments, the computing system might include, without limitation, one of a data flow analyzer, a code analyzer, a software debugging system, a processor of a user device running an app, a server computer over a network, a cloud-based computing system over a network, or a distributed computing system, and/or the like. In some instances, the software code for testing might include, but is not limited to, at least one of source code, code for a software application, code for a computer game, code for a web application, code for a computer program, code for an operating system, or code for transferring data, and/or the like.

Merely by way of example, according to some embodiments, the software code 120 might include code 130 and might also include, without limitation, at least one of build file 135a, manifest file 135b, class file(s) 135c, or Java archive (“JAR”) file 135d, and/or the like, associated with the software code.

In operation, the computing system 105a or computing system 105b (collectively, “computing system 105” or the like) might receive a software code 120 (or 130) for testing (in some cases, from user device 115, while in other cases, from a device or system in or via network(s) 125, or the like). At least one divisible point for each of one or more portions of the received software code 120 (or 130) might be identified. In some embodiments, identifying the at least one divisible point for each of the one or more portions of the received software code 120 (or 130) might comprise identifying (either manually or using the computing system 105) at least one divisible point for each of one or more portions of the received software code 120 (or 130) based at least in part on critical dependencies of the software code. Here, critical dependencies might refer to libraries, subroutines, other portions of the software code, and/or the like, to which the software code must refer in order for the software code to execute properly or as intended. In other words, if references or links between these critical dependencies and the software code are broken or left out, the software code would fail to function properly, as intended, or at all. For example, a system that is designed to track automobile ownership may have two primary objects: (i) a person object and (ii) a vehicle object. Both have methods and attributes, and there are critical dependencies between both. The system might have three primary tiers: (1) a user interface layer (for user interaction), (2) a business logic layer (which reflects programmatic language describing business rules and processes, or the like), and (3) a data layer (where metadata and data is persisted that describe interactions between the person and vehicle objects). The code can be logically split by dividing the code between solely supporting person objects, solely supporting vehicle objects, and code that supports interactions between both types of objects. This can be further broken down by isolating code relationships that flow through the entire stack (e.g., user interface (“UI”), application, data, and/or the like) as it pertains to objects and relationships.

Alternatively, identifying the at least one divisible point for each of the one or more portions of the received software code 120 (or 130) might comprise identifying, with the computing system 105, at least one divisible point for each of one or more portions of the received software code 120 (or 130) based at least in part on contents of at least one of a build file 135a, a manifest file 135b, a class file 135c, or a Java archive (“JAR”) file 135d, and/or the like, associated with the software code 130. According to some embodiments, identifying the at least one divisible point for each of the one or more portions of the received software code 120 (or 130) based at least in part on contents of the at least one of the build file 135a, the manifest file 135b, the class file 135c, or the JAR file 135d, and/or the like, might comprise analyzing, with the computing system 105, the contents of the at least one of the build file 135a, the manifest file 135b, the class file 135c, or the JAR file 135d, and/or the like, that are associated with the software code to identify one or more critical dependencies of the software code 130; and identifying, with the computing system 105, at least one divisible point for each of one or more portions of the received software code 120 (or 130) based at least in part on the one or more identified critical dependencies of the software code.

In some embodiments, the computing system 105 might divide the software code into the one or more portions based at least in part on the identified at least one divisible point for each of the one or more portions of the received software code. In some cases, each of the one or more portions, after being divided, is an atomic element of the software code that is capable of execution independent of other portions of the software code. In some instances, dividing the software code into the one or more portions based at least in part on the identified at least one divisible point for each of the one or more portions of the received software code might comprise dividing the software code into the one or more portions without preventing execution of each of the one or more portions of the received software code.

According to some embodiments, the computing system 105 might analyze at least one portion of the one or more portions of the received software code—to check for or identify software “bugs,” errors, vulnerabilities, coding inefficiencies, or other coding defects, and/or the like—, where each of the at least one portion might be analyzed separately from analysis of other ones of the at least one portion of the received software code. In some cases, analyzing the at least one portion of the one or more portions of the received software code might comprise comparing each of the one or more portions of the received software code with a previous version of the corresponding one or more portions of the received software code to identify which portions of the received software code has changed; and analyzing each of the identified changed portions of the received software code.

The code division algorithm and process described herein specifically provides for autonomous (or semi-autonomous) identification of atomic units or atomic elements of code. This should not be confused with the idea of unit code or unit testing—as “unit” in the software development context has a different meaning compared with atomic code element or atomic elements of code. In particular, code division (according to the various embodiments) breaks down or divides software code into atomic components that can each be evaluated or executed as an independent, standalone element (hence, the use of the term “atomic” element). There may be a temptation to confuse this with unit code (as in unit testing or the like)—but unit code closer aligns to developmental tasks and schedule, and is not necessarily atomic in nature. Rather, unit code can have critical dependencies outside of that unit of code, and thus cannot be evaluated or executed as an independent, standalone element.

For example, when developing unit code and performing traditional unit testing, a programmer might write a set of software-driven functions, grouped together to meet a set of functional requirements. But, the unit of code that the programmer develops and checks in to a source repository will have critical dependencies outside of the piece of code that has been written. Such pieces of code will inherit multiple external libraries, and likely will rely on many existing components already included in the core system, and likely will rely on (or depend on) other pieces of code. In contrast, the code slice routine (in accordance with the code division embodiments described herein) is looking for atomic elements of functionality and lines of delineation leveraging system engineering concepts associated with object-based and object-oriented development to optimize code evaluation. Hence, code division is distinct from unit testing.

In general, the various embodiments provide advantages over conventional data flow or code analysis in that by using code division in accordance with the various embodiments, software code may be divided into multiple code portions along logical breaking points such that each of the multiple code portions may be executed properly or as intended, while being executed independently of other code portions. The advantages of such code division include that when the code is being tested prior to launch of the software code as a product or service, such divided portions may be tested without the need to test other portions. Thus, any changes to particular portions of the code need only necessitate testing, software compilation, and/or execution of those particular portions without having to test, compile, or execute unchanged portions of the code. This results in vastly more efficient testing of the code (and in a less time-consuming manner), as the whole software code need not be tested, compiled, or executed in view of the change to just a portion(s) of the software code (as would be required by conventional data flow or code analysis). Not only is such testing of the software code made more efficient during pre-launch testing that seek to identify software “bugs,” errors, vulnerabilities, coding inefficiencies, or other coding defects, but such methodologies may be implemented after launch should software “bugs,” errors, vulnerabilities, coding inefficiencies, or other coding defects be found in at least some portions of the software code. In those situations, only the affected portions need be changed and tested, after code division (in accordance with the various embodiments). In this manner, data flow analysis or code analysis may be performed in a significantly shorter time compared with conventional data flow analysis or code analysis techniques—from hours to minutes.

Further, by using the code division (as described in accordance with the various embodiments), regular software compilation (or alternatively, regular execution) of the software code may be made more efficient and less time-consuming, as the divided code portions may be compiled (or executed) concurrently or in parallel with each other, thereby significantly reducing the time by which the software code is compiled (or executed).

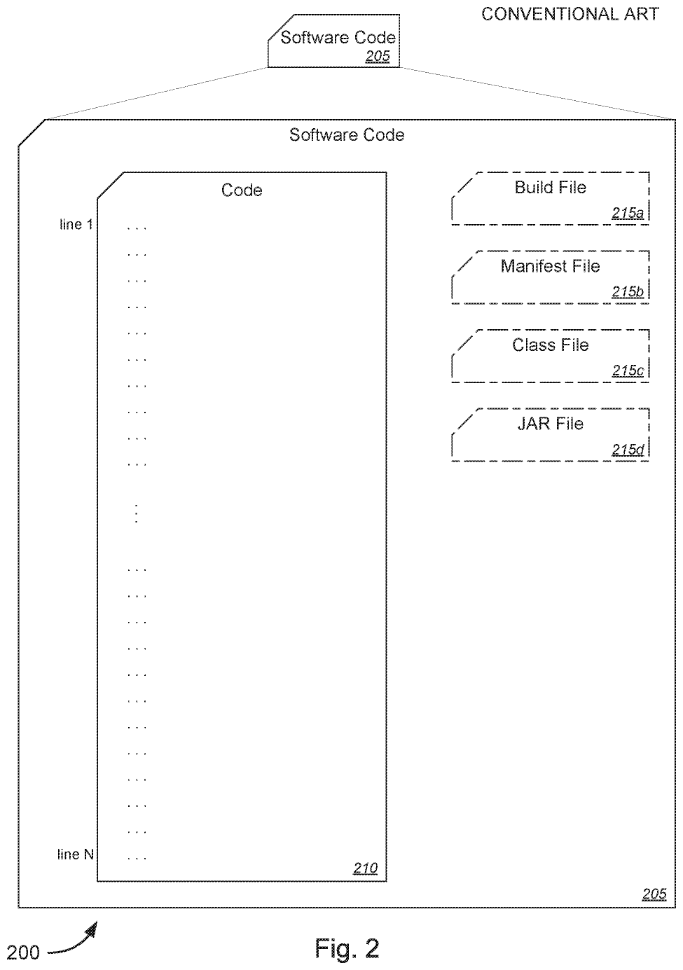

These and other aspects of the various embodiments are described in detail below with respect to FIGS. 2-4.

FIG. 2 is a schematic diagram illustrating an example 200 of the structure of a conventional software code. In example 200 of FIG. 2, software code 205 might comprise code 210, which might include lines 1 through N of the code that constitute the entirety of the code. For the code 210 to function (to be compiled, or to be executed) properly or as intended, the code 210 (within line 1 through line N) might make reference to (necessary) content, information, data, or libraries in at least one of a build file 215a, a manifest file 215b, a class file 215c, or a Java archive (“JAR”) file 215d, and/or the like, associated with the code 210.

During testing, during debugging, or after any change to any segment of the code 210, the entire code 210 must be tested, compiled, and/or executed to ensure that the software code 205 is functioning properly or as intended. This may require many hours of testing per change in even one line of code, especially if the code 210 contains millions of lines of code or more. This is compounded should there be many subsequent changes in even small segments of the code 210.

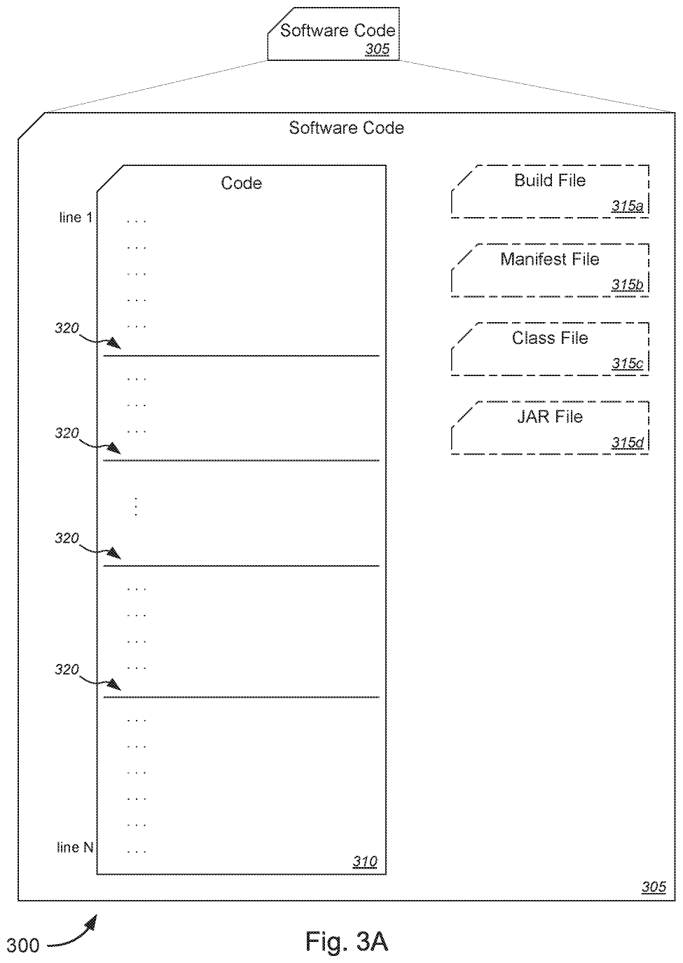

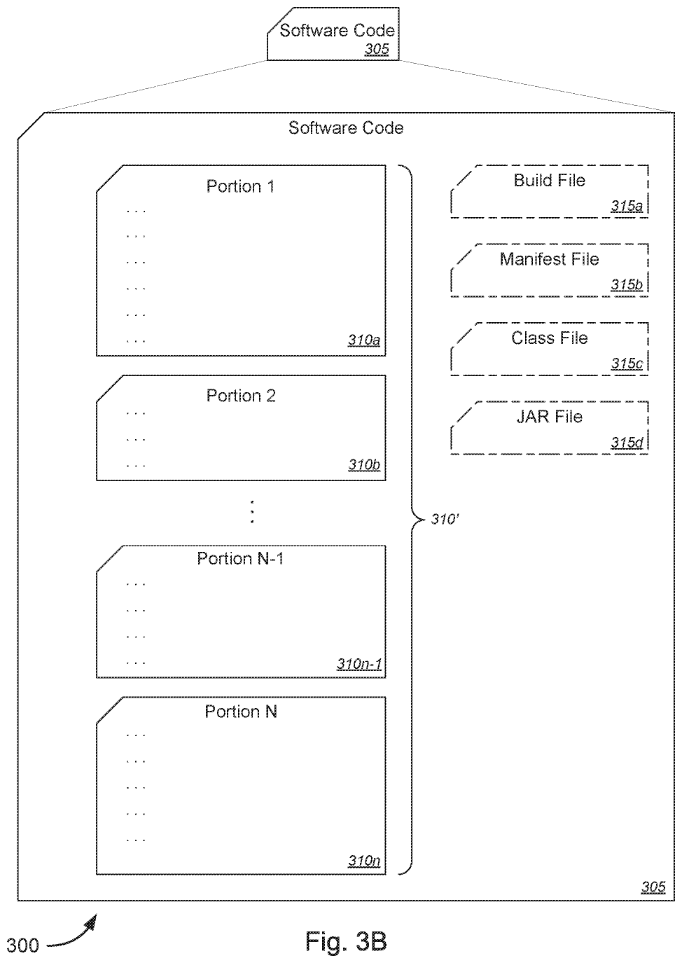

This problem with the conventional data flow or code analysis is resolved by the code division as described with respect to the various embodiments, and which is illustrated with respect to FIGS. 3A and 3B below.

FIGS. 3A and 3B (collectively, “FIG. 3”) are schematic diagrams illustrating an example 300 of the structure of software code that may be code divided during implementation of analysis of data flow or code, in accordance with various embodiments. In example 300 of FIG. 3A, software code 305, like software code 205 of FIG. 2, might comprise code 310, which might include lines 1 through N of the code that constitute the entirety of the code. For the code 310 to function (to be compiled, or to be executed) properly or as intended, the code 310 (within line 1 through line N) might make reference to (necessary) content, information, data, or libraries in at least one of a build file 315a, a manifest file 315b, a class file 315c, or a Java archive (“JAR”) file 315d, and/or the like, associated with the code 310.

Unlike the conventional data flow or code analysis as discussed above with respect to FIG. 2, the various embodiments employ code division as described herein in accordance with the various embodiments. In particular, as described above with respect to FIG. 1, a computing system (e.g., computing system 105 of FIG. 1, or the like) might, after receiving software code 305 for testing (for regular software compilation, or for regular execution), identify at least one divisible point 320 in code 310. In some cases, such identification may be performed manually. The computing system (e.g., computing system 105 of FIG. 1, or the like) might subsequently divide code 310 into one or more portions 310a, 310b, through 310n-1, and 310n (collectively, “code portions 310′,” “portions 310′,” or the like), as shown in FIG. 3B. Here, the code 310 is divided along logical breaking points 320 (as shown in FIG. 3A) such that each divided portion 310′ may be executed (or may function) properly or as intended, independently of other divided portions 310′. In other words, each divided portion 310′, after being divided, is an atomic element of the software code 305 that is capable of execution independent of other portions 310′ of the software code 305. At least one portion of the one or more portions 310′ may then be analyzed, where analysis of the at least one portion 310′ may be performed separately from analysis of other ones of the at least one portion 310′ [i.e., during testing, during debugging, or after any change to any segment of the code 310 (in any change to any segment in each of the at least one portion 310′)]. This reduces the time for testing software code 305 (due to changes in only particular portions 310′ (and not all portions 310′ of the code 310)) because only the affected or changed portions 310′ need be tested. Even if all portions 310′ of the code 310 are changed or affected, code division as described herein allow for parallel or concurrent testing, software compilation, or execution, thereby also reducing the time for testing, software compilation, and execution, respectively. In this manner, instead of hours upon hours of testing per change, testing, compiling, and/or executing code may be achieved in minutes.

Although the above example is described in terms of testing of the software code 305, code division in accordance with the various embodiments may also be used during regular software compilation (or alternatively, regular execution) of the software code 305, so that the portions 310′ may be compiled (or executed) concurrently or in parallel with each other, thereby reducing compiling (or execution) time of the software code 305 as a whole. Because each divided portion 310′ may be compiled (or executed) or may function properly or as intended, independent of other divided portions 310′, such significant reduction in compiling (or execution) times may be achieved (as opposed to conventional data flow or code analysis). In this manner, instead of hours upon hours of software compilation (or execution), compiling (or execution) of software code 305 may be achieved in minutes.

Further, data flow analysis may be improved by the code division techniques described in accordance with the various embodiments. In particular, data flow analysis—which is a technique for ascertaining possible sets of values that may be calculated at various points in the software code (or program), and may track which parts of the software code (or program) a particular value assigned to a variable may propagate —may benefit from code division (as described herein) as data flow analysis may be performed on divided portions of the software code in a concurrent manner, thus reducing overall data flow analysis times. Alternatively, it may be determined that only some (but not all) portions need undergo data flow analysis, in which case data flow analysis may be performed on only particular portions (but not all portions) of the software code, thereby improving the efficiency of the analysis.

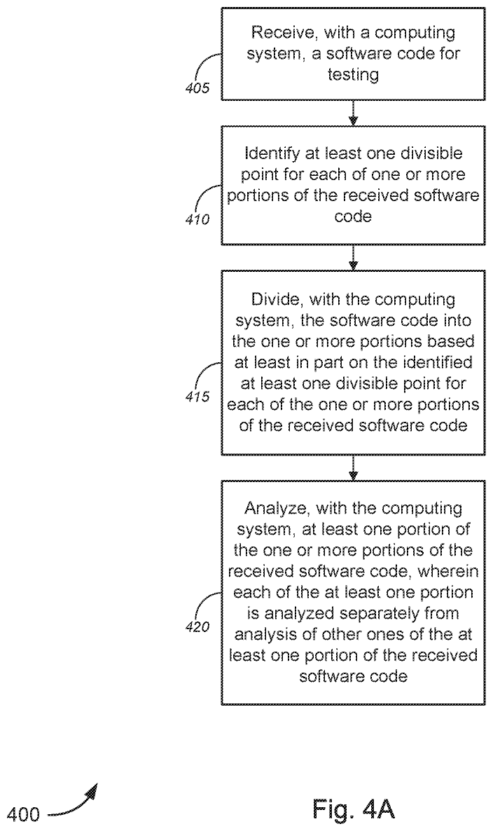

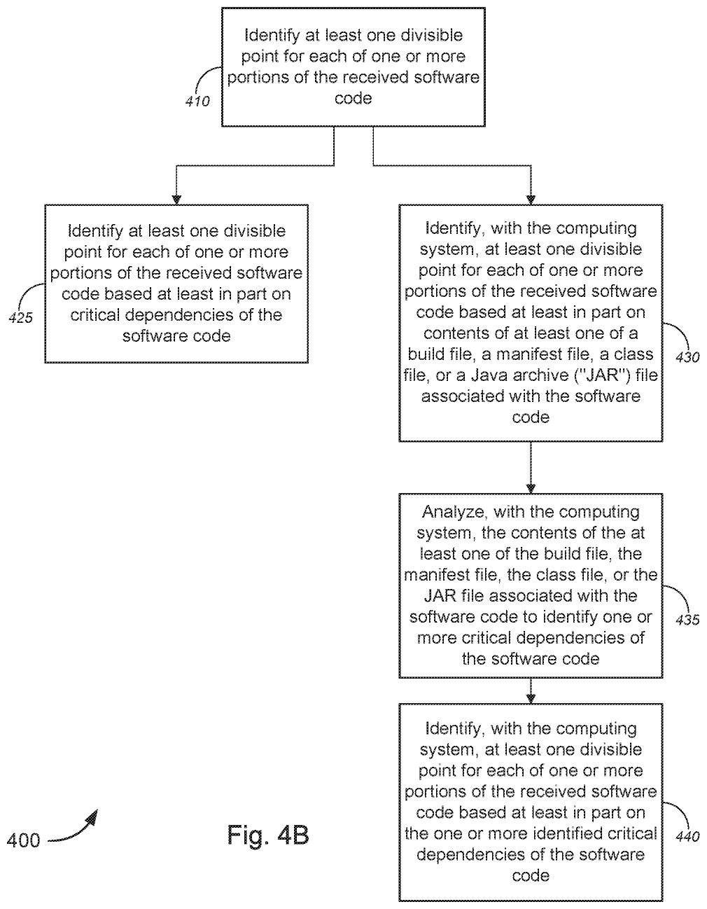

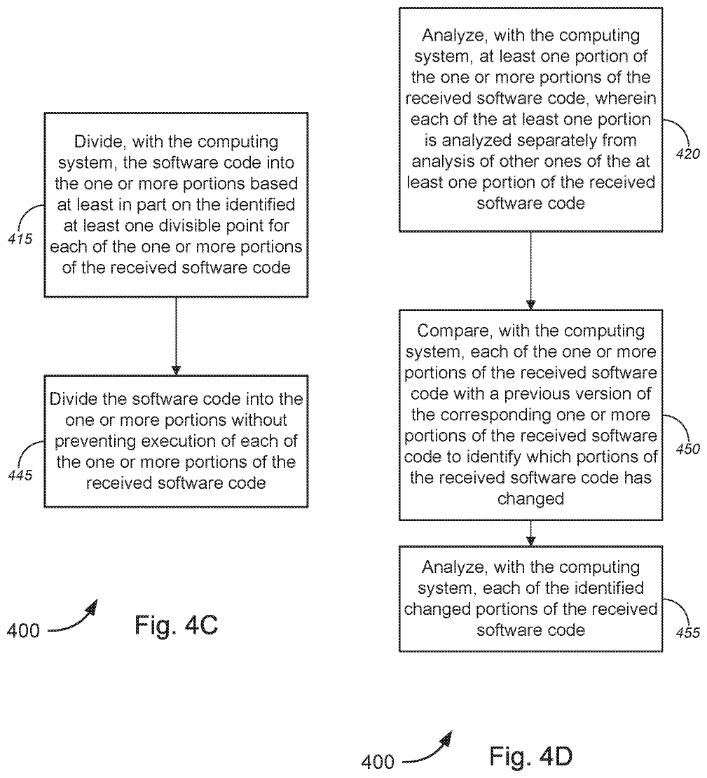

FIGS. 4A-4D (collectively, “FIG. 4”) are flow diagrams illustrating a method 400 for implementing analysis of data flow or code using code division, in accordance with various embodiments.

While the techniques and procedures are depicted and/or described in a certain order for purposes of illustration, it should be appreciated that certain procedures may be reordered and/or omitted within the scope of various embodiments. Moreover, while the method 400 illustrated by FIG. 4 can be implemented by or with (and, in some cases, are described below with respect to) the systems, examples, or embodiments 100 300 of FIGS. 1, 3A, and 3B, respectively (or components thereof), such methods may also be implemented using any suitable hardware (or software) implementation. Similarly, while each of the systems, examples, or embodiments 100 and 300 of FIGS. 1, 3A, and 3B, respectively (or components thereof), can operate according to the method 400 illustrated by FIG. 4 (e.g., by executing instructions embodied on a computer readable medium), the systems, examples, or embodiments 100 and 300 of FIGS. 1, 3A, and 3B can each also operate according to other modes of operation and/or perform other suitable procedures.

In the non-limiting embodiment of FIG. 4A, method 400, at block 405, might comprise receiving, with a computing system, a software code for testing. In some embodiments, the computing system might include, without limitation, one of a data flow analyzer, a code analyzer, a software debugging system, a processor of a user device running an app, a server computer over a network, a cloud-based computing system over a network, or a distributed computing system, and/or the like. In some instances, the software code for testing might include, but is not limited to, at least one of source code, code for a software application, code for a computer game, code for a web application, code for a computer program, code for an operating system, or code for transferring data, and/or the like.

At block 410, method 400 might comprise identifying at least one divisible point for each of one or more portions of the received software code. In some cases, the at least one divisible point might be a logical breaking point between two portions of the one or more portions of the received software code.

Method 400 might further comprise dividing, with the computing system, the software code into the one or more portions based at least in part on the identified at least one divisible point for each of the one or more portions of the received software code (block 415). In some cases, each of the one or more portions, after being divided, is an atomic element of the software code that is capable of execution independent of other portions of the software code. Method 400 might further comprise, at block 420, analyzing, with the computing system, at least one portion of the one or more portions of the received software code, wherein each of the at least one portion is analyzed separately from analysis of other ones of the at least one portion of the received software code.

With reference to FIG. 4B, identifying the at least one divisible point for each of the one or more portions of the received software code (at block 410) might comprise identifying at least one divisible point for each of one or more portions of the received software code based at least in part on critical dependencies of the software code (block 425). Here (as described above), critical dependencies might refer to libraries, subroutines, other portions of the software code, and/or the like, to which the software code must refer in order for the software code to execute properly or as intended. In other words, if references or links between these critical dependencies and the software code are broken or left out, the software code would fail to function properly, as intended, or at all. All software code must include compiler directives to some degree. For example, in java software code, there is a build file and, in some cases, a manifest (or a manifest file). The build file identifies critical components and critical dependencies from a compilation perspective. Build files have a static set of attributes, grouped as either tasks or properties that loosely describe the dependencies. A build file may have a task that constructs pieces of the code into java archive repository (“JAR”) files, which define a logical grouping of dependent code units into an atomic (or self-contained) code. The manifest (or manifest file) might contain information or metadata about the files packaged in each JAR file.

Alternatively, identifying the at least one divisible point for each of the one or more portions of the received software code (at block 410) might comprise identifying, with the computing system, at least one divisible point for each of one or more portions of the received software code based at least in part on contents of at least one of a build file, a manifest file, a class file, or a Java archive (“JAR”) file, and/or the like, associated with the software code (block 430). According to some embodiments, identifying the at least one divisible point for each of the one or more portions of the received software code based at least in part on contents of the at least one of the build file, the manifest file, the class file, or the JAR file (at block 430) might comprise analyzing, with the computing system, the contents of the at least one of the build file, the manifest file, the class file, or the JAR file associated with the software code to identify one or more critical dependencies of the software code (block 435); and identifying, with the computing system, at least one divisible point for each of one or more portions of the received software code based at least in part on the one or more identified critical dependencies of the software code (block 440).

Referring to FIG. 4C, dividing the software code into the one or more portions based at least in part on the identified at least one divisible point for each of the one or more portions of the received software code (at block 415) might comprise dividing the software code into the one or more portions without preventing execution of each of the one or more portions of the received software code (block 445).

Turning to FIG. 4D, analyzing the at least one portion of the one or more portions of the received software code (at block 420) might comprise comparing, with the computing system, each of the one or more portions of the received software code with a previous version of the corresponding one or more portions of the received software code to identify which portions of the received software code has changed (block 450); and analyzing, with the computing system, each of the identified changed portions of the received software code (block 455).

### Exemplary System and Hardware Implementation

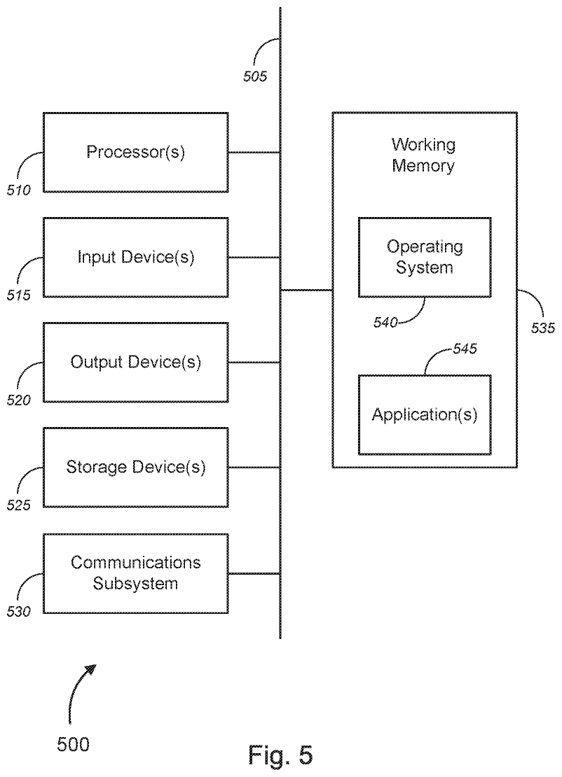

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., computing systems 105a and 105b, user device(s) 115, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., computing systems 105a and 105b, user device(s) 115, etc.), described above with respect to FIGS. 1-4—is shown comprising hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further comprise a working memory 535, which can include a RAM or ROM device, as described above.

The computer or hardware system 500 also may comprise software elements, shown as being currently located within the working memory 535, including an operating system 540, device drivers, executable libraries, and/or other code, such as one or more application programs 545, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that comprise the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

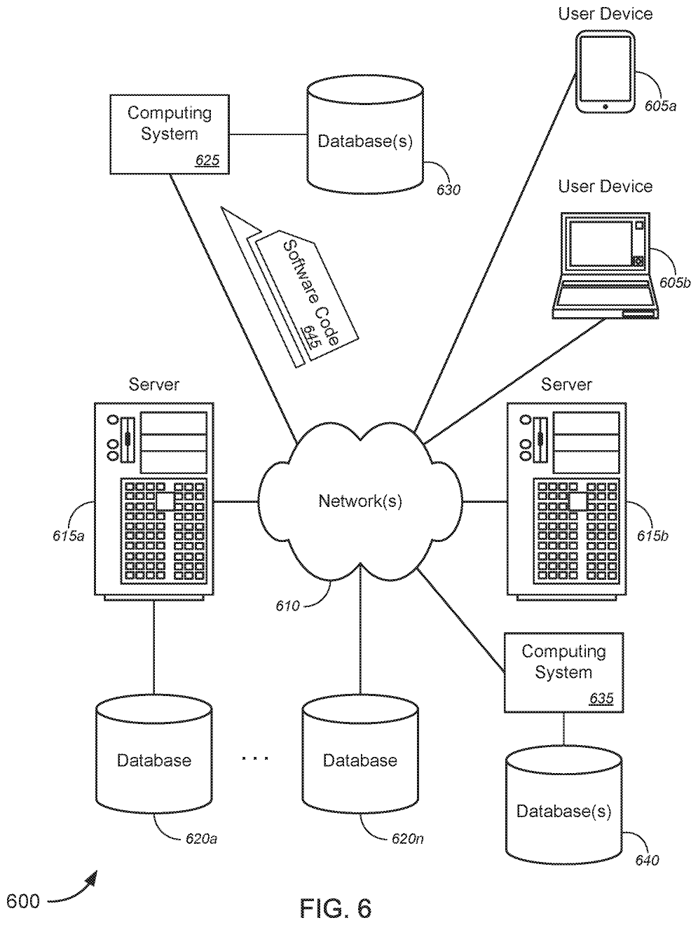

As noted above, a set of embodiments comprises methods and systems for implementing data flow or code analysis, and, more particularly, to methods, systems, and apparatuses for implementing analysis of data flow or code using code division. FIG. 6 illustrates a schematic diagram of a system 600 that can be used in accordance with one set of embodiments. The system 600 can include one or more user computers, user devices, or customer devices 605. A user computer, user device, or customer device 605 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX™ or UNIX-like operating systems. A user computer, user device, or customer device 605 can also have any of a variety of applications, including one or more applications configured to perform methods provided by various embodiments (as described above, for example), as well as one or more office applications, database client and/or server applications, and/or web browser applications. Alternatively, a user computer, user device, or customer device 605 can be any other electronic device, such as a thin-client computer, Internet-enabled mobile telephone, and/or personal digital assistant, capable of communicating via a network (e.g., the network(s) 610 described below) and/or of displaying and navigating web pages or other types of electronic documents. Although the exemplary system 600 is shown with two user computers, user devices, or customer devices 605, any number of user computers, user devices, or customer devices can be supported.

Certain embodiments operate in a networked environment, which can include a network(s) 610. The network(s) 610 can be any type of network familiar to those skilled in the art that can support data communications using any of a variety of commercially-available (and/or free or proprietary) protocols, including, without limitation, TCP/IP, SNA™, IPX™, AppleTalk™, and the like. Merely by way of example, the network(s) 610 (similar to network(s) 125 FIG. 1, or the like) can each include a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 615. Each of the server computers 615 may be configured with an operating system, including, without limitation, any of those discussed above, as well as any commercially (or freely) available server operating systems. Each of the servers 615 may also be running one or more applications, which can be configured to provide services to one or more clients 605 and/or other servers 615.

Merely by way of example, one of the servers 615 might be a data server, a web server, a cloud computing device(s), or the like, as described above. The data server might include (or be in communication with) a web server, which can be used, merely by way of example, to process requests for web pages or other electronic documents from user computers 605. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 605 to perform methods of the invention.

The server computers 615, in some embodiments, might include one or more application servers, which can be configured with one or more applications accessible by a client running on one or more of the client computers 605 and/or other servers 615. Merely by way of example, the server(s) 615 can be one or more general purpose computers capable of executing programs or scripts in response to the user computers 605 and/or other servers 615, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer, user device, or customer device 605 and/or another server 615. In some embodiments, an application server can perform one or more of the processes for implementing data flow or code analysis, and, more particularly, to methods, systems, and apparatuses for implementing analysis of data flow or code using code division, as described in detail above. Data provided by an application server may be formatted as one or more web pages (comprising HTML, JavaScript, etc., for example) and/or may be forwarded to a user computer 605 via a web server (as described above, for example). Similarly, a web server might receive web page requests and/or input data from a user computer 605 and/or forward the web page requests and/or input data to an application server. In some cases, a web server may be integrated with an application server.

In accordance with further embodiments, one or more servers 615 can function as a file server and/or can include one or more of the files (e.g., application code, data files, etc.) necessary to implement various disclosed methods, incorporated by an application running on a user computer 605 and/or another server 615. Alternatively, as those skilled in the art will appreciate, a file server can include all necessary files, allowing such an application to be invoked remotely by a user computer, user device, or customer device 605 and/or server 615.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620a-620n (collectively, “databases 620”). The location of each of the databases 620 is discretionary: merely by way of example, a database 620a might reside on a storage medium local to (and/or resident in) a server 615a (and/or a user computer, user device, or customer device 605). Alternatively, a database 620n can be remote from any or all of the computers 605, 615, so long as it can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605, 615 can be stored locally on the respective computer and/or remotely, as appropriate.) In one set of embodiments, the database 620 can be a relational database, such as an Oracle database, that is adapted to store, update, and retrieve data in response to SQL-formatted commands. The database might be controlled and/or maintained by a database server, as described above, for example.

According to some embodiments, system 600 might further comprise a computing system 625 and corresponding database(s) 630 (similar to computing system 105a and corresponding database(s) 110a of FIG. 1, or the like), a remote computing system 635 and corresponding database(s) 640 (similar to computing system 105b and corresponding database(s) 110b of FIG. 1, or the like).

In operation, the computing system 625 or computing system 635 (collectively, “computing system” or the like) might receive a software code 645 for testing (in some cases, from user device 605a or 605b, while in other cases, from a device or system in or via network(s) 610, or the like). At least one divisible point for each of one or more portions of the received software code 645 might be identified (either manually or using the computing system). In some embodiments, the computing system might divide the software code 645 into the one or more portions based at least in part on the identified at least one divisible point for each of the one or more portions of the received software code 645. In some cases, each of the one or more portions, after being divided, is an atomic element of the software code that is capable of execution independent of other portions of the software code. According to some embodiments, the computing system might analyze at least one portion of the one or more portions of the received software code 645—to check for or identify software “bugs,” errors, vulnerabilities, coding inefficiencies, or other coding defects, and/or the like—, where each of the at least one portion might be analyzed separately from analysis of other ones of the at least one portion of the received software code.

These and other functions of the system 600 (and its components) are described in greater detail above with respect to FIGS. 1-4.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, with a computing system, a software code for testing;
identifying at least one divisible point for each of one or more portions of the received software code;
dividing, with the computing system, the software code into the one or more portions based at least in part on the identified at least one divisible point for each of the one or more portions of the received software code, wherein each of the one or more portions, after being divided, is an atomic element of the software code that is capable of execution independent of other portions of the software code; and
analyzing, with the computing system, at least one portion of the one or more portions of the received software code, wherein each of the at least one portion is analyzed separately from analysis of other ones of the at least one portion of the received software code.

2. The method of claim 1, wherein the computing system comprises one of a data flow analyzer, a code analyzer, a software debugging system, a processor of a user device running an app, a server computer over a network, a cloud-based computing system over a network, or a distributed computing system.

3. The method of claim 1, wherein the software code for testing comprises at least one of source code, code for a software application, code for a computer game, code for a web application, code for a computer program, code for an operating system, or code for transferring data.

4. The method of claim 1, wherein the at least one divisible point is a logical breaking point between two portions of the one or more portions of the received software code.

5. The method of claim 1, wherein identifying the at least one divisible point for each of the one or more portions of the received software code comprises identifying at least one divisible point for each of one or more portions of the received software code based at least in part on critical dependencies of the software code.

6. The method of claim 1, wherein identifying the at least one divisible point for each of the one or more portions of the received software code comprises identifying, with the computing system, at least one divisible point for each of one or more portions of the received software code based at least in part on contents of at least one of a build file, a manifest file, a class file, or a Java archive (“JAR”) file associated with the software code.

7. The method of claim 6, wherein identifying the at least one divisible point for each of the one or more portions of the received software code based at least in part on contents of the at least one of the build file, the manifest file, the class file, or the JAR file comprises:
analyzing, with the computing system, the contents of the at least one of the build file, the manifest file, the class file, or the JAR file associated with the software code to identify one or more critical dependencies of the software code; and
identifying, with the computing system, at least one divisible point for each of one or more portions of the received software code based at least in part on the one or more identified critical dependencies of the software code.

8. The method of claim 1, wherein dividing the software code into the one or more portions based at least in part on the identified at least one divisible point for each of the one or more portions of the received software code comprises dividing the software code into the one or more portions without preventing execution of each of the one or more portions of the received software code.

9. The method of claim 1, wherein analyzing the at least one portion of the one or more portions of the received software code comprises:
comparing, with the computing system, each of the one or more portions of the received software code with a previous version of the corresponding one or more portions of the received software code to identify which portions of the received software code has changed; and
analyzing, with the computing system, each of the identified changed portions of the received software code.

10. An apparatus, comprising:
at least one processor; and
a non-transitory computer readable medium communicatively coupled to the at least one processor, the non-transitory computer readable medium having stored thereon computer software comprising a set of instructions that, when executed by the at least one processor, causes the apparatus to:
receive a software code for testing;
identify at least one divisible point for each of one or more portions of the received software code;
divide the software code into the one or more portions based at least in part on the identified at least one divisible point for each of the one or more portions of the received software code, wherein each of the one or more portions, after being divided, is an atomic element of the software code that is capable of execution independent of other portions of the software code; and
analyze at least one portion of the one or more portions of the received software code, wherein each of the at least one portion is analyzed separately from analysis of other ones of the at least one portion of the received software code.

11. The apparatus of claim 10, wherein the apparatus comprises one of a data flow analyzer, a code analyzer, a software debugging system, a processor of a user device running an app, a server computer over a network, a cloud-based computing system over a network, or a distributed computing system.

12. The apparatus of claim 10, the software code for testing comprises at least one of source code, code for a software application, code for a computer game, code for a web application, code for a computer program, code for an operating system, or code for transferring data.

13. The apparatus of claim 10, wherein the at least one divisible point is a logical breaking point between two portions of the one or more portions of the received software code.

14. The apparatus of claim 10, wherein identifying the at least one divisible point for each of the one or more portions of the received software code comprises identifying at least one divisible point for each of one or more portions of the received software code based at least in part on critical dependencies of the software code.

15. The apparatus of claim 10, wherein identifying the at least one divisible point for each of the one or more portions of the received software code comprises identifying at least one divisible point for each of one or more portions of the received software code based at least in part on contents of at least one of a build file, a manifest file, a class file, or a Java archive (“JAR”) file associated with the software code.

16. The apparatus of claim 10, wherein identifying the at least one divisible point for each of the one or more portions of the received software code based at least in part on contents of the at least one of the build file, the manifest file, the class file, or the JAR file comprises:
analyzing the contents of the at least one of the build file, the manifest file, the class file, or the JAR file associated with the software code to identify one or more critical dependencies of the software code; and
identifying at least one divisible point for each of one or more portions of the received software code based at least in part on the one or more identified critical dependencies of the software code.

17. The apparatus of claim 10, wherein dividing the software code into the one or more portions based at least in part on the identified at least one divisible point for each of the one or more portions of the received software code comprises dividing the software code into the one or more portions without preventing execution of each of the one or more portions of the received software code.

18. The apparatus of claim 10, wherein analyzing the at least one portion of the one or more portions of the received software code comprises:
comparing each of the one or more portions of the received software code with a previous version of the corresponding one or more portions of the received software code to identify which portions of the received software code has changed; and
analyzing each of the identified changed portions of the received software code.

19. A system, comprising:
a computing system, comprising:
at least one processor; and
a non-transitory computer readable medium communicatively coupled to the at least one processor, the non-transitory computer readable medium having stored thereon computer software comprising a set of instructions that, when executed by the at least one processor, causes the computing system to:
receive a software code for testing;
identify at least one divisible point for each of one or more portions of the received software code;
divide the software code into the one or more portions based at least in part on the identified at least one divisible point for each of the one or more portions of the received software code, wherein each of the one or more portions, after being divided, is an atomic element of the software code that is capable of execution independent of other portions of the software code; and
analyze at least one portion of the one or more portions of the received software code, wherein each of the at least one portion is analyzed separately from analysis of other ones of the at least one portion of the received software code.

20. The system of claim 19, the computing system comprises one of a data flow analyzer, a code analyzer, a software debugging system, a processor of a user device running an app, a server computer over a network, a cloud-based computing system over a network, or a distributed computing system.
